(19) United States
(12) Patent Application Publication
(10) Pub. No.: US 2026/0066603 A1
(43) Pub. Date: Mar. 5, 2026

(54) RAMAN-EDFA HYBRID AMPLIFIER FOR EXTENDED L BAND AMPLIFICATION

(71) Applicant: Ii-VI Delaware, Inc., Wilmington, DE (US)

(72) Inventors: Chunli Tao, Wilmington, DE (US); Jun Han, Wilmington, DE (US); Yonghao Xu, Wilmington, DE (US); Yongjun Fu, Wilmington, DE (US); Yongshi Gu, Wilmington, DE (US)

(21) Appl. No.: 18/887,867

(22) Filed: Sep. 17, 2024

(30) Foreign Application Priority Data
Sep. 4, 2024 (CN) 2024112380700

(51) Int. Cl. H01S 3/067; H01S 3/094; H01S 3/10; H01S 3/16; H01S 3/30

(52) U.S. Cl. CPC H01S 3/06716; H01S 3/094046; H01S 3/1001; H01S 3/1608; H01S 3/302; H01S 2301/02

(57) ABSTRACT

Embodiments of the present disclosure comprise an optical amplifier system, with the system comprising an erbium-doped fiber amplifier comprising a C band EDFA configured to generate C band light, and an L band EDFA configured to generate L Band light. A Raman amplifier comprising a fiber span may be pumped using a backward pump light.

### TECHNICAL FIELD

The present disclosure generally relates to a Raman-EDFA hybrid amplifier for extended L band amplification.

### BACKGROUND

Aspects of the present disclosure relate to a Raman-EDFA hybrid amplifier for extended L band amplification. In this regard, conventional amplifier systems may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims is a Raman-EDFA hybrid amplifier for extended L band amplification.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 is a block diagram illustrating an optical amplifier system, according to some embodiments of the present disclosure.

FIG. 2 shows illustrative gain v. wavelength plots.

FIG. 3 to FIG. 10 show an optical amplifier system 100, according to some embodiments of the present disclosure.

### DETAILED DESCRIPTION

The following discussion provides various examples of a system for a Raman-EDFA hybrid amplifier for extended L band amplification. Such examples are non-limiting, and the scope of the appended claims should not be limited to the particular examples disclosed. In the following discussion, the terms “example”and “e.g.,”are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “comprises,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Embodiments of the present disclosure may comprise an optical amplifier system, the system comprising an erbium-doped fiber amplifier comprising a C band EDFA configured to generate C band light and an L band EDFA configured to generate L Band light.

Embodiments may also comprise a Raman amplifier comprising a fiber span. In accordance with various embodiments, the Raman amplifier may be pumped using a backward pump light. Embodiments may also comprise a first filter to receive a signal light from the fiber span and operable to split the signal light into an L band signal light component and a C band signal light component. Embodiments may also comprise a wavelength selector to receive the C band signal light and the backward pump light, operable to couple the C band signal light to the C band EDFA and operable to couple the backward pump light to the first filter.

In accordance with various embodiments, the backward pump light may be a C band amplified spontaneous emission light generated in the L band EDFA and coupled to the wavelength selector via a second filter. In accordance with various embodiments, the second filter may be further operable to receive the L band signal light component and operable to couple the L band signal light component to the L band EDFA.

In accordance with various embodiments, the C band amplified spontaneous emission light after passing through the second filter traverses a third filter and a second C band EDFA before being coupled to the wavelength selector. In accordance with various embodiments, the third filter may be a narrow band filter. In accordance with various embodiments, the third filter may have a center bandwidth at 1530 nm.

In accordance with various embodiments, the second C band EDFA amplifies its input light to around a power of 500 mW at its output. In accordance with various embodiments, the C band amplified spontaneous emission light after passing through the second filter traverses a third filter and an S band EDFA before being coupled to the wavelength selector.

In accordance with various embodiments, the third filter may be a narrow band filter. In accordance with various embodiments, the third filter has a center bandwidth at 1520 nm. In accordance with various embodiments, the S band EDFA amplifies its input light to around a power of 300 mW at its output. In accordance with various embodiments, the backward pump light may be used to pump a high Raman gain fiber coupled between the fiber span and the first filter. In accordance with various embodiments, the high Raman gain fiber may be operable to amplify the signal light before the fiber span.

In accordance with various embodiments, the backward pump light may be generated by a seed source. In accordance with various embodiments, the seed source may be a SFP, a DFB, or a TOSA. In accordance with various embodiments, the seed source generates the backward pump light at a wavelength of 1520 nm. In accordance with various embodiments, the generated backward pump light may be coupled to the wavelength selector via an S band EDFA.

In accordance with various embodiments, the S band EDFA amplifies its input light to around a power of 300 mW at its output. In accordance with various embodiments, the backward pump light may be generated by a SOA source. In accordance with various embodiments, the generated backward pump light may be coupled to the wavelength selector via a SOA amplifier.

In accordance with various embodiments, the backward pump light may be generated by a pump unit. In accordance with various embodiments, the pump unit may comprise a plurality of lasers generating light at a wavelength of 1520 nm and the output of the plurality of lasers may be optically combined. In accordance with various embodiments, the backward pump light may comprise a first backward pump light generated by a first order Raman pump coupled to the wavelength selector, and a second backward pump light generated by a second order Raman pump coupled between the fiber span and the first filter. In accordance with various embodiments, the second order Raman pump may be pumped by the first backward pump light to generate the second backward pump light.

In accordance with various embodiments, the first order Raman pump may comprise a plurality of lasers generating light at 1300 nm and the output of the plurality of lasers may be optically combined. Embodiments may also comprise a second order Raman pump that may comprise a plurality of lasers generating light at 1400 nm and the output of the plurality of lasers may be optically combined. In accordance with various embodiments, the wavelength selector may comprise a circulator, a filter, a wavelength selection switch, or any component operable to select and transmit specific wavelength light.

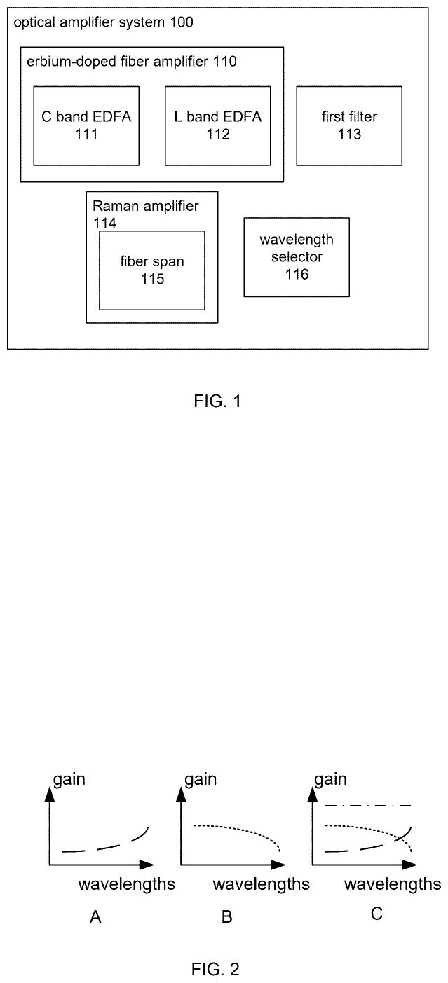

Referring now to FIG. 1, FIG. 1 is a block diagram that describes an optical amplifier system 100, according to some embodiments of the present disclosure. The optical amplifier system 100 may comprise an erbium-doped fiber amplifier (EDFA) 110. The erbium-doped fiber amplifier 110 may include a C band EDFA 111 configured to generate C band light, an L band EDFA 112 configured to generate L Band light. The optical amplifier system 100 may further comprise a Raman amplifier 114, and a first filter 113 to receive a signal light from the fiber span 115 and operable to split the signal light into an L band signal light component and a C band signal light component. The optical amplifier system 100 further comprises a wavelength selector 116 to receive the C band signal light and the backward pump light, operable to couple the C band signal light to the C band EDFA 111 and operable to couple the backward pump light to the first filter 113. The Raman amplifier 114 may include a fiber span 115. The Raman amplifier 114 may be pumped using a backward pump light.

In this disclosure, C band and L band generically refer also to an extended C band and an extended L band, respectively. For example, in accordance with various embodiments, the L band and C band may refer to exemplary bands of 4.5 THz or 6 THz. An extended C band, for example, may range from a wavelength of 1524 nm to 1572 nm and is referred to generically as C band in this disclosure. An extended L band, for example, may range from a wavelength of 1575 nm to 1626 nm and is referred to generically as L band in this disclosure.

The EDFA 110 comprising a C band EDFA 111 and an L band EDFA 112 may be an amplifier using optical fiber comprising erbium ions, referred to as erbium-doped material. Erbium (Er) may be a rare earth element that may possess special optical properties, particularly in the ability to absorb and emit light in the infrared wavelength range. This property makes erbium-doped materials useful in a variety of optical applications, including erbium-doped fiber amplifiers.

During the fabrication of an optical fiber, small amounts of erbium ions may be intentionally introduced into the core of the fiber. This may be referred to as erbium doping. When these ions in the fiber are excited with external light sources (pump light, often around 980 nm or 1480 nm, for example) and an input signal is injected into the fiber, the excited erbium ions may release energy in the form of additional photons that may be in phase and coherent with the input optical signal light, thereby effectively amplifying the input signal without the need for electrical-to-optical conversion. In accordance with various embodiments of the invention, the EDFA 110 may comprise multiple amplifier stages operable in distinct operating bands, namely a C-band stage 111 and an L-band stage 112.

The Raman amplifier 114 may be another type of optical amplifier used in fiber-optic communication systems to amplify optical signals. Unlike erbium-doped fiber amplifiers (EDFAs), which rely on the properties of erbium-doped materials, Raman amplifiers may exploit the Raman scattering phenomenon to achieve signal amplification.

Raman scattering may be a nonlinear optical process where light may interact with the vibrational modes of the material through which it is traveling. When a pump laser is launched into an optical fiber, it may create vibrational modes within the fiber material. These modes may interact with incident signal light, causing energy transfer from the pump light to the signal light. As a result, the signal light may get amplified through the Raman scattering process. The fiber may be a fiber span 115.

Raman amplifiers may provide amplification in a wide range of wavelengths and exhibit low noise levels, depending on e.g., the pump wavelength, the pump power, the length of the fiber span 115 and the interaction between the pump wavelength and the input light wavelength.

By combining a Raman amplifier 114 with an EDFA 110, a hybrid optical amplifier system 100 may be created. Such a system may combine the relative advantages of EDFAs and Raman amplifiers. In accordance with various embodiments of the present disclosure, the Raman amplifier 114 may extend the amplification bandwidth in the L band bandwidths. In other words, a hybrid approach may allow for optimized signal amplification across a broader wavelength range while also benefiting from the noise performance and well-established technology of EDFAs.

FIG. 2 shows illustrative gain v. wavelength plots for A: Raman amplifier 114 (dashed line), B: EDFA 110 (dotted line), C: combined gain of the hybrid amplifier (dash-dot line).

As may be seen from A, the Raman amplifier 114 may be configured to generate an increased gain at larger wavelengths, for example at the L band wavelengths of 1616 nm to 1626 nm and larger, e.g., 1575 nm to 1626 nm. As may be seen from B, the EDFA 110 may generate a larger gain at shorter wavelengths. The gain of EDFA 110 may drop in the higher L band wavelengths. As may be seen from C, the combined gain of the Raman amplifier 114 stage and the EDFA 110 stage may be substantially flat over a range of wavelengths, as illustrated by the dash-dot line.

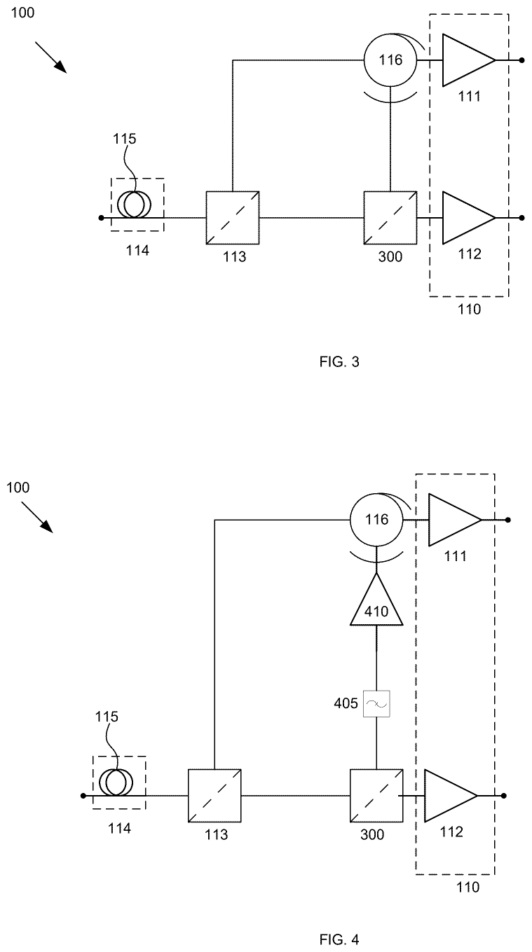

FIG. 3 shows an optical amplifier system 100, according to some embodiments of the present disclosure. There is further shown a second filter 300.

The backward pump light may be a C band amplified spontaneous emission light generated in the L band EDFA 112 and coupled to the wavelength selector 116 via a second filter 300. The backward pump light then is coupled from the wavelength selector 116 to the first filter 113 from where it is fed into the Raman amplifier 114 as a backward pump light.

The second filter 300 may be further operable to receive the L band signal light component from the first filter 113 and operable to couple the L band signal light component to the L band EDFA 112.

In some embodiments, the wavelength selector 116 may comprise a circulator, a filter, a wavelength selection switch, and/or any component operable to select and transmit specific wavelength light.

FIG. 4 shows an optical amplifier system 100, according to some embodiments of the present disclosure. There is further shown a third filter 405 and a C band EDFA 410.

In some embodiments, the C band backward pump light generated at L band EDFA 112 after passing through the second filter 300 may traverse a third filter 405 and a second C band EDFA 410 before being coupled to the wavelength selector 116. The third filter 405 may be a narrow band filter. In some embodiments, the third filter 405 may include a center bandwidth at 1530 nm. In some embodiments, the second C band EDFA 410 may amplify its input light to around a power of 500 mW at its output. Thus, the backward pump light may be bandwidth limited and amplified before being coupled into the wavelength selector 116.

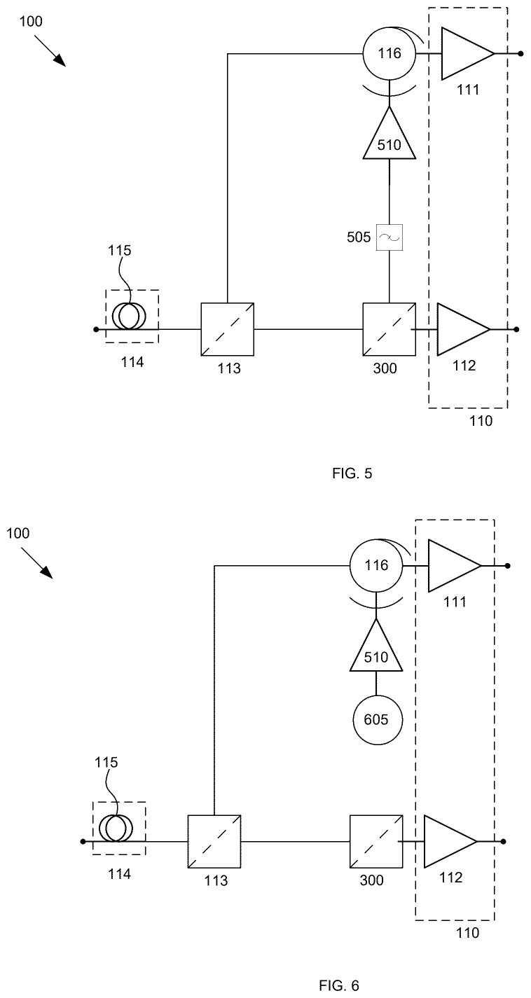

FIG. 5 shows an optical amplifier system 100, according to some embodiments of the present disclosure. There is further shown a third filter 505 and an S band EDFA 510. In some embodiments, the C band backward pump signal after passing through the second filter 300 may traverse a third filter 505 and an S band EDFA 510 before being coupled to the wavelength selector 116. The third filter 505 may be a narrow band filter. The third filter 505 may include a center bandwidth at 1520 nm. In some embodiments, the S band EDFA 510 may amplify its input light to around a power of 300 mW at its output. Thus, the backward pump light may be bandwidth limited and amplified before being coupled into the wavelength selector 116.

FIG. 6 shows an optical amplifier system 100, according to some embodiments of the present disclosure. There is further shown a seed source 605.

The backward pump light may be generated by a seed source 605. In some embodiments, the seed source may be a Small Form-factor Pluggable (SFP), a Distributed Feedback Laser (DFB), or a Transmitter Optical Sub-Assembly (TOSA). In some embodiments, the seed source may generate the backward pump light at a wavelength of 1520 nm. In some embodiments, the generated backward pump light may be coupled to the wavelength selector 116 via an S band EDFA 510. In some embodiments, the S band EDFA 510 may amplify its input light to around a power of 300 mW at its output.

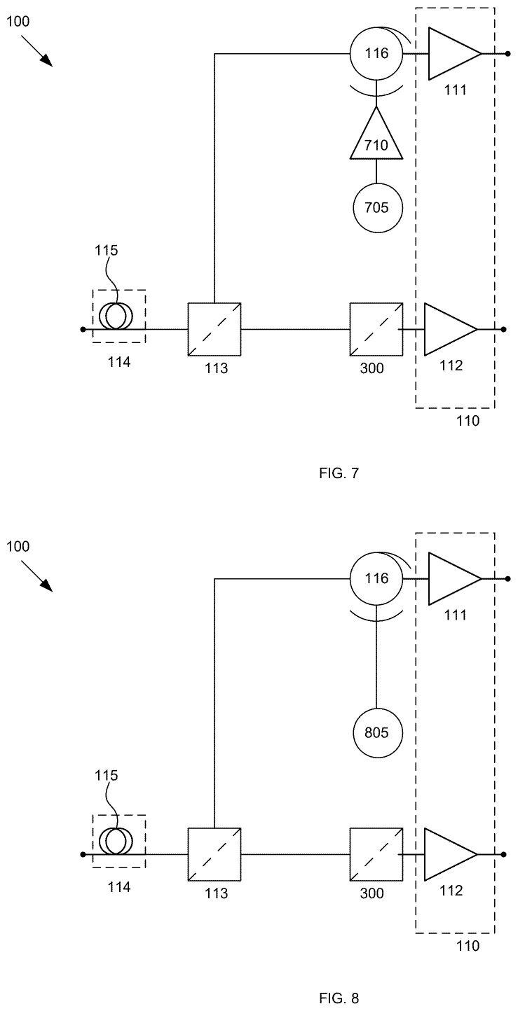

FIG. 7 shows an optical amplifier system 100, according to some embodiments of the present disclosure. There is further shown a Semiconductor Optical Amplifier (SOA) source 705 and a SOA amplifier 710.

The backward pump light may be generated by a SOA source 705. In some embodiments, the generated backward pump light may be coupled to the wavelength selector 116 via an SOA amplifier 710.

FIG. 8 shows an optical amplifier system 100, according to some embodiments of the present disclosure. There is further shown a pump unit 805.

The backward pump light may be generated by a pump unit. In some embodiments, the pump unit may include a plurality of lasers generating light at a wavelength of 1520 nm and the output of the plurality of lasers may be optically combined.

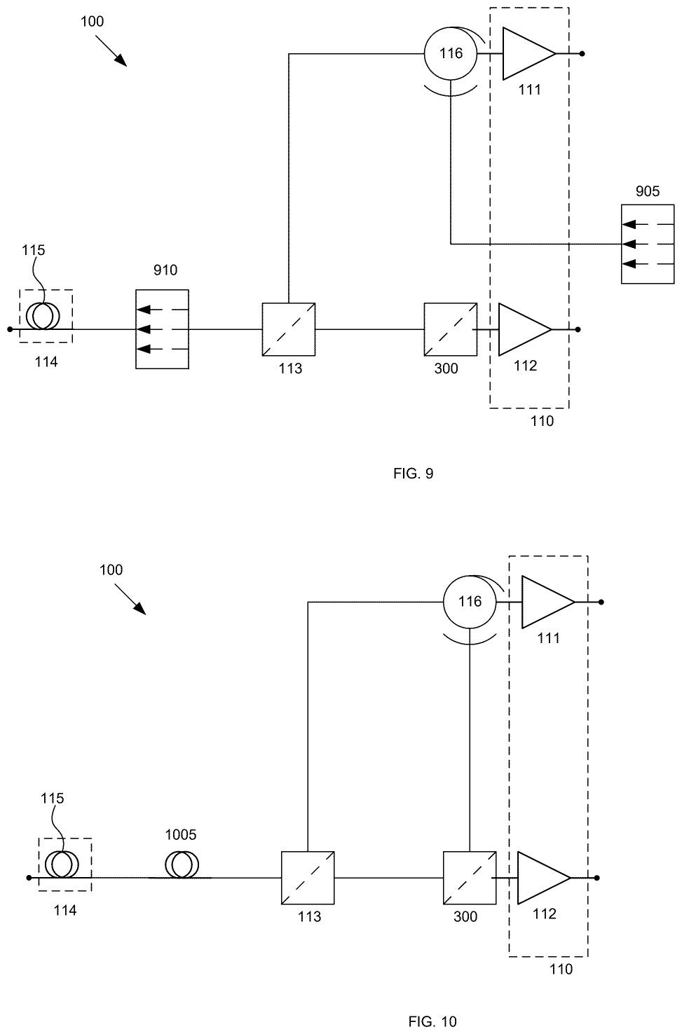

FIG. 9 shows an optical amplifier system 100, according to some embodiments of the present disclosure. There is further shown a first-order Raman pump 905 and a second order Raman pump 910.

The backward pump light may be generated in two Raman stages. A first backward pump light may be generated in a first order Raman pump 905. The second order Raman pump 910 may be pumped by the first backward pump light to generate a second backward pump light, that may pump the Raman amplifier 114. In some embodiments, the first order Raman pump 905 may include a plurality of lasers generating light at 1300 nm and the output of the plurality of lasers may be optically combined.

FIG. 10 shows an optical amplifier system 100, according to some embodiments of the present disclosure. There is further shown a high Raman-gainfiber 1005.

In some embodiments, the backward pump light may be used to pump a high Raman-gainfiber 1005 coupled between the fiber span 115 and the first filter 113. The high Raman gain fiber 1005 may be operable to pre-amplify the signal light before the fiber span 115.

The present disclosure comprises reference to certain examples; however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will comprise all examples falling within the scope of the appended claims.

What is claimed is:

1. An optical amplifier system, said system comprising:
an erbium-doped fiber amplifier comprising
a C band EDFA configured to generate C band light;
an L band EDFA configured to generate L Band light;
a Raman amplifier comprising a fiber span, and wherein said Raman amplifier is pumped using a backward pump light;
a first filter to receive a signal light from said fiber span and operable to split said signal light into an L band signal light component and a C band signal light component;
a wavelength selector to receive said C band signal light and said backward pump light, operable to couple said C band signal light to said C band EDFA and operable to couple said backward pump light to said first filter.

2. The system of claim 1, wherein said backward pump light is a C band amplified spontaneous emission light generated in said L band EDFA and coupled to said wavelength selector via a second filter.

3. The system of claim 2, wherein said second filter is further operable to receive said L band signal light component and operable to couple said L band signal light component to said L band EDFA.

4. The system of claim 2, wherein said C band amplified spontaneous emission light after passing through said second filter traverses a third filter and a second C band EDFA before being coupled to said wavelength selector.

5. The system of claim 4, wherein said third filter is a narrow band filter.

6. The system of claim 4, wherein said third filter has a center bandwidth at 1530 nm.

7. The system of claim 4, wherein said second C band EDFA amplifies its input light to around a power of 500 mW at its output.

8. The system of claim 2, wherein said C band amplified spontaneous emission light after passing through said second filter traverses a third filter and an S band EDFA before being coupled to said wavelength selector.

9. The system of claim 8, wherein said third filter is a narrow band filter.

10. The system of claim 8, wherein said third filter has a center bandwidth at 1520 nm.

11. The system of claim 8, wherein said S band EDFA amplifies its input light to around a power of 300 mW at its output.

12. The system of claim 1, wherein said backward pump light is generated by a seed source.

13. The system of claim 12, wherein said seed source is a SFP, a DFB, or a TOSA.

14. The system of claim 12, wherein said seed source generates said backward pump light at a wavelength of 1520 nm.

15. The system of claim 12, wherein said generated backward pump light is coupled to said wavelength selector via an S band EDFA.

16. The system of claim 15, wherein said S band EDFA amplifies its input light to around a power of 300 mW at its output.

17. The system of claim 1, wherein said backward pump light is generated by a SOA source.

18. The system of claim 17, wherein said generated backward pump light is coupled to said wavelength selector via an SOA amplifier.

19. The system of claim 1, wherein said backward pump light is generated by a pump unit.

20. The system of claim 19, wherein said pump unit comprises a plurality of lasers generating light at a wavelength of 1520 nm and the output of said plurality of lasers are optically combined.

21. The system of claim 1, wherein said backward pump light comprises a first backward pump light generated by a first order Raman pump coupled to said wavelength selector, and a second backward pump light generated by a second order Raman pump coupled between said fiber span and said first filter, and wherein said second order Raman pump is pumped by said first backward pump light to generate said second backward pump light.

22. The system of claim 21, wherein said first order Raman pump comprises a plurality of lasers generating light at 1300 nm and the output of said plurality of lasers are optically combined.

23. The system of claim 21, wherein a second order Raman pump comprises a plurality of lasers generating light at 1400 nm and the output of said plurality of lasers are optically combined.

24. The system of claim 1, wherein said backward pump light is used to pump a high Raman gain fiber coupled between said fiber span and said first filter, and wherein said high Raman gain fiber is operable to amplify said signal light before said fiber span.

25. The system of claim 1, wherein said wavelength selector comprises a circulator, a filter, a wavelength selection switch, or any component operable to select and transmit specific wavelength light.
